(19) United States
(12) Patent Application Publication
(10) Pub. No.: US 2006/0125595 A1
(43) Pub. Date: Jun. 15, 2006

(54) Electrical plug for vehicle use

(75) Inventor: Chen-Lun Lu, Taichung City (TW)

Correspondence Address: FROMMER LAWRENCE & HAUG, 745 FIFTH AVENUE- 10TH FL., NEW YORK, NY, 10151, US

(73) Assignee: Potrans Electrical Corp. Ltd.

(21) Appl. No.: 11/010,935

(22) Filed: Dec. 13, 2004

(51) Int. Cl. H01H 85/02; H01H 85/20

(52) U.S. Cl. 337/186

(57) ABSTRACT

An electrical plug for vehicle use includes a housing and a fuse. The housing includes a plug end, a connecting end opposite to the plug end, and a receiving chamber between the plug end and the connecting end. The fuse is mounted in the receiving chamber. The housing further includes a window portion that is registered with the receiving chamber to permit viewing of the fuse.

### BACKGROUND OF THE INVENTION

1. Field of the Invention

The invention relates to an electrical plug, more particularly to an electrical plug for vehicle use.

2. Description of the Related Art

Referring to FIGS. 1 and 2, a conventional electrical plug 10 for use in a vehicle, such as a car (not shown), includes a housing 11 and a fuse 12. The housing 11 defines a receiving chamber 113, and includes a plug end 111 for connecting electrically to a power socket of the vehicle, and a connecting end 112 opposite to the plug end 111. The fuse 12 is disposed within the receiving chamber 113.

In use, when there is a current overload, the fuse 12 burns out automatically so as to interrupt the flow of electricity and thereby stop operation of an electrical appliance. This protects the appliance and avoids electrical hazards.

However, in actual use, since the housing 11 fully covers the fuse 12, and since the housing 11 is usually made of a non-transparent material, when the appliance to which the plug 10 is applied does not operate, and assuming that the problem is simply that of the fuse 12 being burned out, the following two situations usually occur:

1. The user is not able to see the fuse 12 in its burned out state so that the appliance is directly sent for repair. Therefore, the user spends more time and money than necessary.

2. A repairman cannot immediately determine the condition of the fuse 12 without removing the plug end 111 of the housing 11, and so he or she performs this process then connects the plug end 111 back to the housing 11. These steps must be performed regardless of whether the fuse 12 is burned out or not, so that the conventional electrical plug 10 provides a further burden during repairs.

### SUMMARY OF THE INVENTION

Therefore, the object of the present invention is to provide an electrical plug having a window portion so as to overcome the aforementioned drawbacks of the prior art.

According to this invention, an electrical plug for vehicle use comprises a housing and a fuse. The housing includes a plug end, a connecting end opposite to the plug end, and a receiving chamber between the plug end and the connecting end. The fuse is mounted in the receiving chamber. The housing further includes a window portion that is registered with the receiving chamber to permit viewing of the fuse.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional electrical plug;

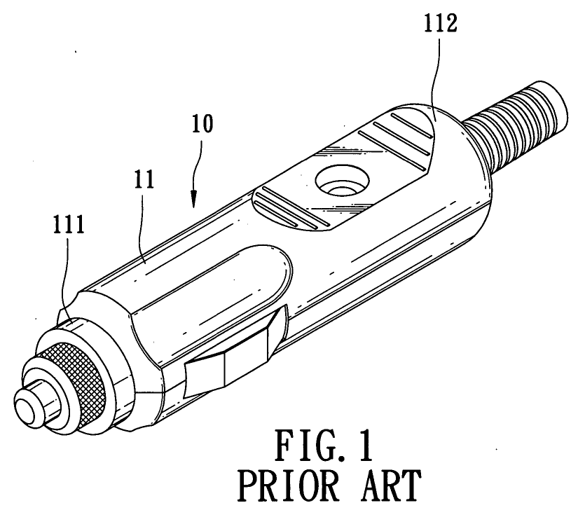

FIG. 2 is a partly sectional view of the conventional electrical plug of FIG. 1;

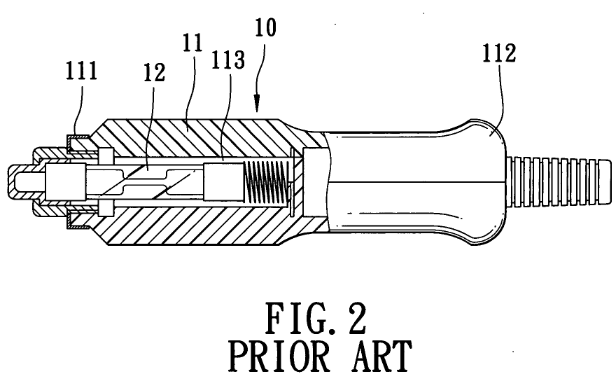

FIG. 3 is a perspective view of the first preferred embodiment of an electrical plug according to the present invention;

FIG. 4 is a partly sectional view of the first preferred embodiment; and

FIG. 5 is a partly sectional view of the second preferred embodiment of an electrical plug according to the present invention.

### DETAILED DESCRIPTION OF THE PREFERRED EMBODIMENTS

Before the present invention is described in greater detail, it should be noted that like elements are denoted by the same reference numerals throughout the disclosure.

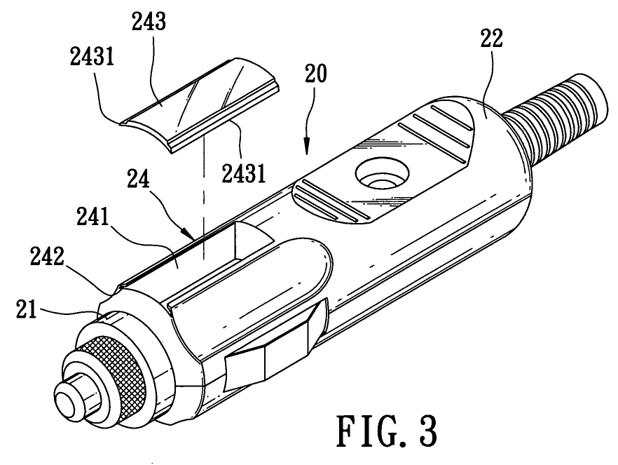

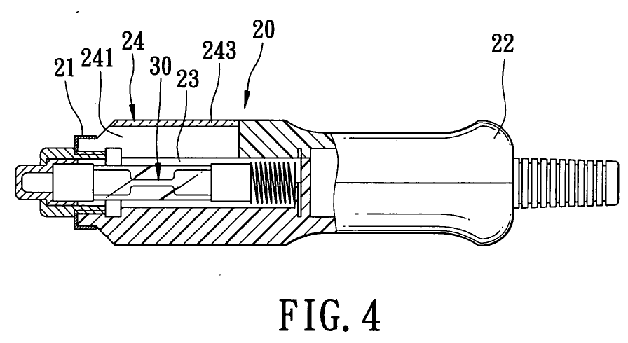

Referring to FIGS. 3 and 4, the first preferred embodiment of an electrical plug for use in a vehicle, such as a car (not shown), according to the present invention is shown to comprise a housing 20 and a fuse 30.

The housing 20 includes a plug end 21 for electrical connection with a power socket in the vehicle, a connecting end 22 opposite to the plug end 21, a receiving chamber 23 between the plug end 21 and the connecting end 22, and a window portion 24 that is registered with the receiving chamber 23.

In this embodiment, the window portion 24 includes an opening 241 in spatial communication with the receiving chamber 23, and a transparent cover plate 243 having two protrusions 2431 projecting outwardly from two opposite sides of the cover plate 243. Two spaced-apart slide rails 242 are provided on two opposite sides of a wall defining the opening 241. The transparent cover plate 243 covers the opening 241 by engaging slidably and respectively the protrusions 2431 with the slide rails 242 of the window portion 24.

The fuse 30 is mounted within the receiving chamber 23.

In use, the user or the repairman can directly view the condition of the fuse 30 through the opening 241 in the window portion 24. If the fuse 30 is in good condition, then there is no need to open the housing 20. If the fuse 30 is burned out, the housing 20 is opened to replace the burned out fuse 30 with a new one. The electrical plug of the present invention, therefore, makes repairs more convenient since the determination of the condition of the fuse 30 may be made without requiring disassembly.

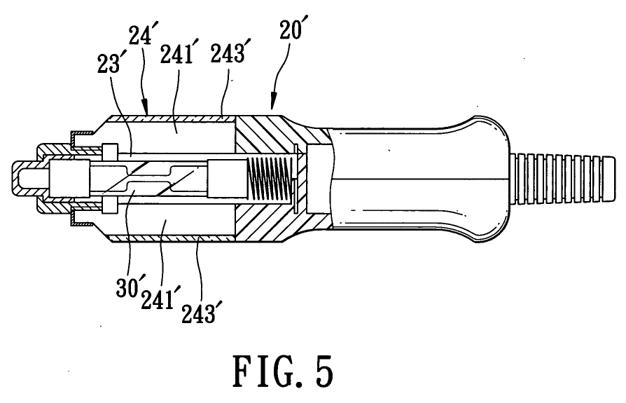

Referring to FIG. 5, the second preferred embodiment of the electrical plug according to the present invention is shown to be similar to the first preferred embodiment. However, in this embodiment, the window portion 24′ includes two openings 241′ in spatial communication with the receiving chamber 23′, and two transparent cover plates 243′ to cover the openings 241′, respectively. The openings 241′ are located on two opposite sides of the receiving chamber 23′ so as to allow the fuse 30′ to be viewed from the two opposite sides of the receiving chamber 23′, as well as allow more light to enter the receiving chamber 23′, thereby permitting the user to better ascertain the condition of the fuse 30.

From the aforementioned description of the first and second preferred embodiments, it is apparent that the feature of the electrical plug of the present invention resides in the construction of the housing 20, 20′ which has a window portion 24, 24′ that permits viewing of the condition of the fuse 30 within the receiving chamber 23, 23′. The transparent cover plate 243, 243′ is not limited to the disclosed embodiment, but may be a transparent adhesive tape which can similarly achieve the purpose of covering the opening 241, 241′ and viewing of the fuse 30.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An electrical plug for vehicle use, comprising:
a housing including a plug end, a connecting end opposite to said plug end, and a receiving chamber between said plug end and said connecting end; and
a fuse mounted in said receiving chamber;
said housing further including a window portion that is registered with said receiving chamber to permit viewing of said fuse.

2. The electrical plug as claimed in claim 1, wherein said window portion includes an opening in spatial communication with said receiving chamber, and a transparent cover plate to cover said opening.

3. The electrical plug as claimed in claim 1, wherein said window portion includes two openings on two opposite sides of and in spatial communication with said receiving chamber, and two transparent cover plates to cover said openings, respectively.
